(19) United States
(12) Patent Application Publication
(10) Pub. No.: US 2010/0032996 A1
(43) Pub. Date: Feb. 11, 2010

(54) SADDLE ASSEMBLY

(75) Inventor: Daniel LEE, Nantou Hsien (TW)

Correspondence Address: MCNEES WALLACE & NURICK LLC, 100 PINE STREET, P.O. BOX 1166, HARRISBURG, PA, 17108-1166, US

(73) Assignee: CIONLLI INDUSTRIAL CO., LTD., Nantou Hsien (TW)

(21) Appl. No.: 12/189,406

(22) Filed: Aug. 11, 2008

(51) Int. Cl. B62J 1/08

(52) U.S. Cl. 297/195.1

(57) ABSTRACT

A saddle assembly includes a saddle body and a support bracket. The saddle body has a bottom side and includes a front converging portion and a rear diverging portion. The rear diverging portion is formed with rear socket holes spaced apart from each other and opening downwardly in the bottom side of the saddle body. The support bracket has a converging front end connected to the front converging portion at the bottom side of the saddle body, a pair of diverging arms that extend rearwardly from the converging front end and that have distal ends opposite to the converging front end, and a pair of rear coupling blocks. The rear coupling blocks are provided on the distal ends of the diverging arms and are inserted upwardly into and engage the rear socket holes to retain the diverging arms on the rear diverging portion at the bottom side of the saddle body.

### BACKGROUND OF THE INVENTION

1. Field of the Invention

This invention relates to a saddle, more particularly to a saddle assembly that can be assembled without requiring exertion of a force to deform a support bracket of the saddle assembly.

2. Description of the Related Art

Referring to FIG. 1, a conventional bicycle saddle 1 includes a saddle body 11 and a support bracket 12. The saddle body 11 has a bottom side and includes a front converging portion 111 that is formed with a front socket hole 113 in the bottom side of the saddle body 11, and a rear diverging portion 112 that is formed with a pair of rear socket holes 114 in the bottom side of the saddle body 11. The front socket hole 113 opens toward the rear diverging portion 112. The rear socket holes 114 are spaced apart from each other and open toward the front converging portion 111.

The support bracket 12, which is used for connecting to a bicycle seat post (not shown) and is made of metal, has a converging front end 121 that is connected to the front converging portion 111 at the bottom side of the saddle body 11, and a pair of diverging arms 122 that extend rearwardly from the converging front end 121 and that have distal ends opposite to the converging front end 121.

When connecting the support bracket 12 to the bottom side of the saddle body 11, the converging front end 121 is inserted into the front socket hole 113 to connect the converging front end 121 to the front converging portion 111 at the bottom side of the saddle body, and a force is then exerted to deform the diverging arms 122 in order to insert each of the distal ends of the diverging arms 122 into a respective one of the rear socket holes 114.

The exerted force is required to deform the support bracket 12 in order to shorten the distance between the converging front end 121 and the distal ends of the diverging arms 122 so that the distal ends of the diverging arms 122 can be inserted into the rear socket holes 114. During the assembling process, the support bracket 12 may be deformed permanently due to an excessive force, thereby adversely affecting the overall structure of the bicycle saddle 1 and resulting in a lower production yield of the bicycle saddle 1.

### SUMMARY OF THE INVENTION

The object of the present invention is to provide a saddle assembly that can overcome the aforesaid drawbacks of the prior art.

According to this invention, a saddle assembly includes a saddle body and a support bracket. The saddle body includes a front converging portion and a rear diverging portion, and has a bottom side. The rear diverging portion is formed with a pair of rear socket holes in the bottom side of the saddle body. The rear socket holes are spaced apart from each other and open downwardly. The support bracket has a converging front end that is connected to the front converging portion at the bottom side of the saddle body, a pair of diverging arms that extend rearwardly from the converging front end and that have distal ends opposite to the converging front end, and a pair of rear coupling blocks. Each of the rear coupling blocks is provided on the distal end of a respective one of the diverging arms and is inserted upwardly into and engages a respective one of the rear socket holes to retain the respective one of the diverging arms on the rear diverging portion at the bottom side of the saddle body.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of a conventional bicycle saddle;

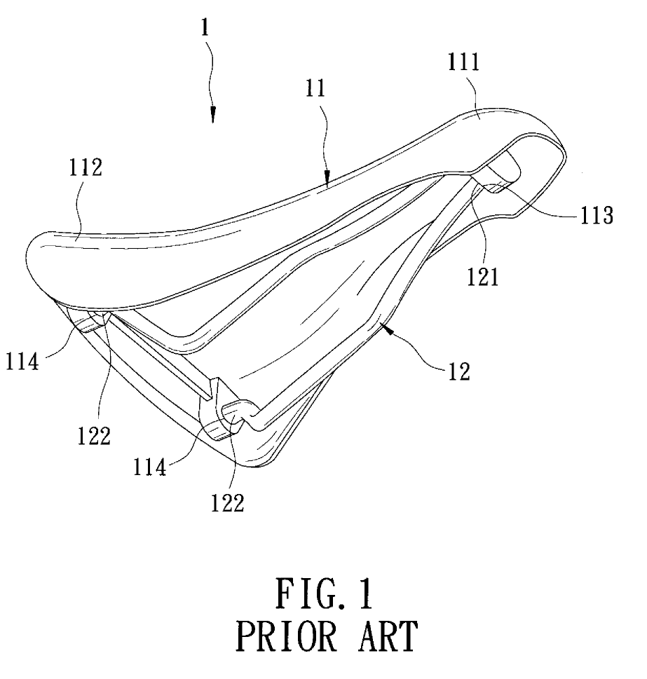

FIG. 2 is an exploded perspective view of the preferred embodiment of a saddle assembly according to this invention;

FIG. 3 is a perspective view of the preferred embodiment; and

FIG. 4 is a sectional view illustrating retention of a rear coupling block in a rear socket hole according to the preferred embodiment.

### DETAILED DESCRIPTION OF THE PREFERRED EMBODIMENT

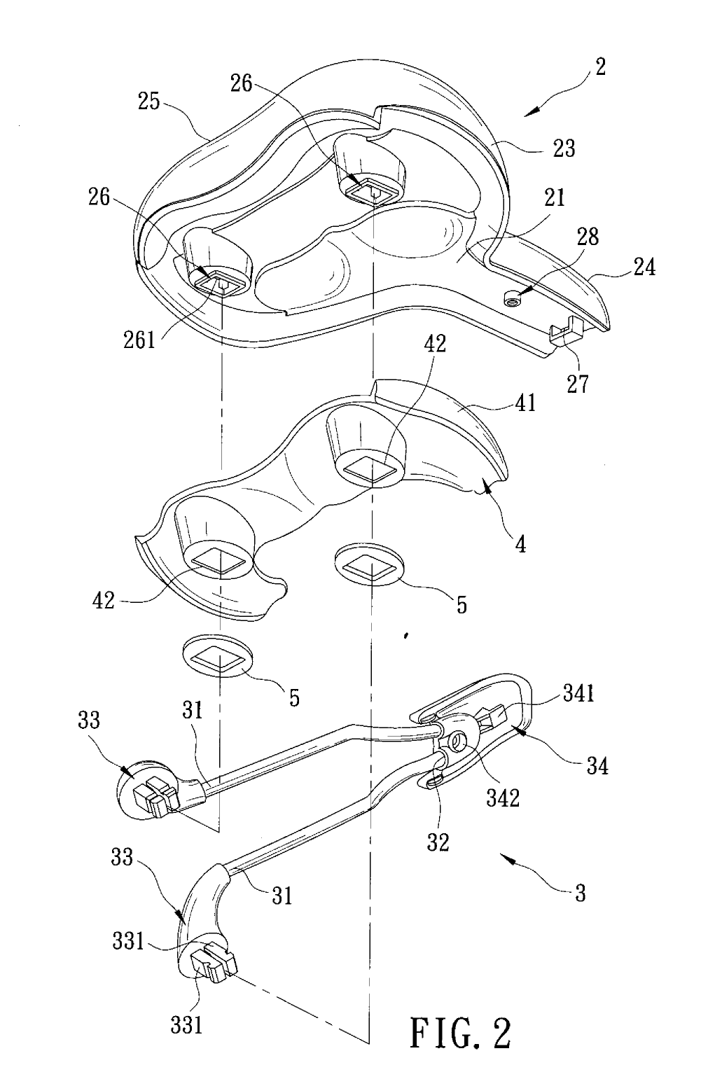

Referring to FIG. 2, the preferred embodiment of a saddle assembly according to the present invention is shown to include a saddle body 2 and a support bracket 3.

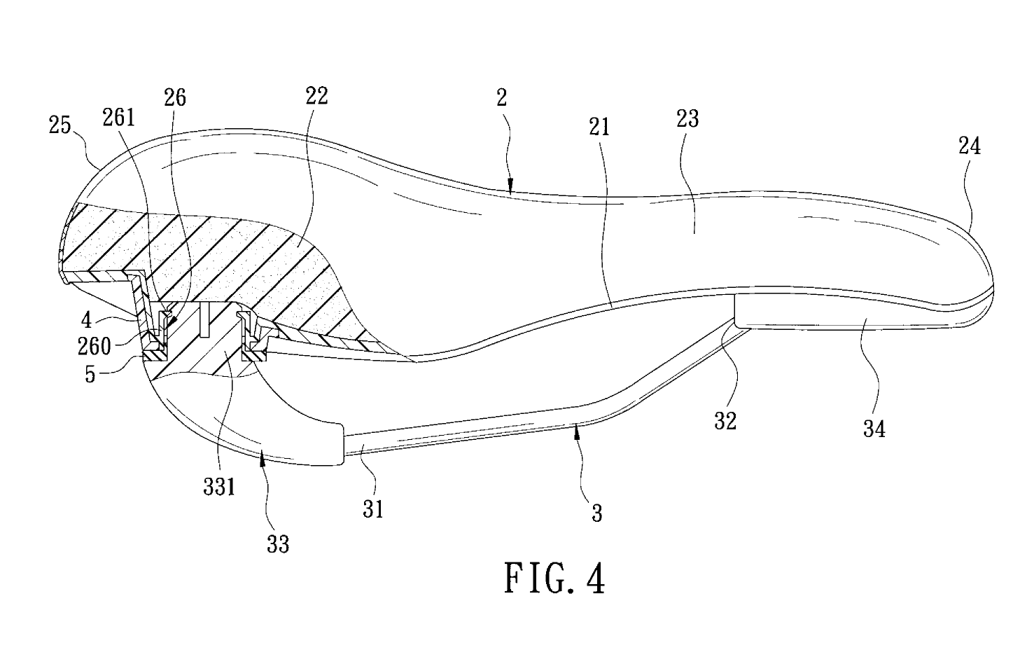

Referring to FIGS. 2 and 4, the saddle body 2 is formed as a three-layer structure including a rigid plastic layer 21 that has a top side and a bottom side, a foam layer 22 that covers the top side of the plastic layer 21, and a skin layer 23 that is made of leather and that covers the foam layer 22. The saddle body 2 includes a front converging portion 24 and a rear diverging portion 25, and has a bottom side. The rear diverging portion 25 is formed with a pair of rear socket holes 26 that are spaced apart from each other and that open downwardly in the bottom side of the saddle body 2, i.e., in the bottom side of the plastic layer 21. The rear diverging portion 25 has a pair of hole-defining walls 260. Each of the hole-defining walls 260 defines a respective one of the rear socket holes 26 and is formed with a retaining flange 261 that extends into the respective one of the rear socket holes 26. The front converging portion 24 is formed with a front socket hole 27 and a screw hole 28 in the bottom side of the saddle body 2, i.e., in the bottom side of the plastic layer 21. The front socket hole 27 opens toward the rear diverging portion 25.

The support bracket 3 is used for connecting to a bicycle seat post (not shown), and has a converging front end 32 that is connected to the front converging portion 24 at the bottom side of the saddle body 2, a pair of diverging arms 31 that extend rearwardly from the converging front end 32 and that have distal ends opposite to the converging front end 32, and a pair of rear coupling blocks 33. In this embodiment, the converging front end 32 and the diverging arms 31 are made of a rigid material such as metal. Each of the rear coupling blocks 33 is provided on the distal end of a respective one of the diverging arms 31. In this embodiment, each of the rear coupling blocks 33 is made from plastic such as rigid plastic and is molded over the distal end of the respective one of the diverging arms 31 such as by injection molding. Each of the rear coupling blocks 33 is inserted upwardly into and engages a respective one of the rear socket holes 26 to retain the respective one of the diverging arms 31 on the rear diverging portion 25 at the bottom side of the saddle body 2. More particularly, each of the rear coupling blocks 33 is formed with a pair of spaced apart resilient hook parts 331 that are inserted upwardly into the respective one of the rear socket holes 26 and that engage the retaining flange 261 in the respective one of the rear socket holes 26 to retain the respective one of the diverging arms 31 on the rear diverging portion 25 at the bottom side of the saddle body 2.

In this embodiment, the support bracket 3 further includes a front coupling block 34 provided on the converging front end 32 to connect the converging front end 32 to the front converging portion 24 at the bottom side of the saddle body 2. More particularly, the front coupling block 34 is formed with an insert portion 341 that is inserted into the front socket hole 27 to connect the converging front end 32 to the front converging portion 24 at the bottom side of the saddle body 2. In this embodiment, the front coupling block 34 is made from plastic such as rigid plastic, and is formed integrally on the converging front end 32 such as by injection molding.

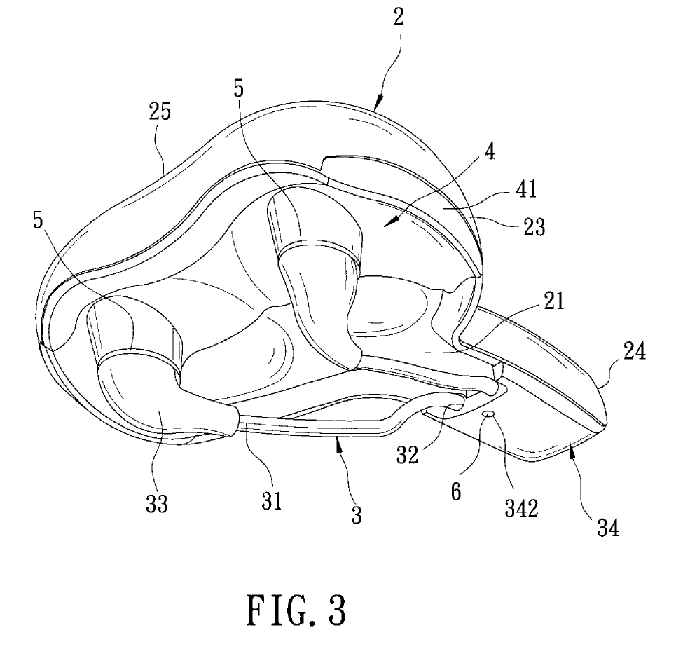

The front coupling block 34 is further formed with a through hole 342 to be aligned with the screw hole 28 in the front converging portion 24. The saddle assembly further includes a screw fastener 6 (see FIG. 3) that extends through the through hole 342 in the front coupling block 34 and that engages threadedly the screw hole 28 in the front converging portion 24. Due to the screw fastener 6, stability of connection between the front coupling block 34 and the front converging portion 24 can be improved.

Referring to FIGS. 2 and 3, the rear diverging portion 25 of the saddle body 2 has opposite lateral surfaces. The saddle assembly further includes a guard member 4 disposed at the bottom side of the saddle body 2 and clamped between the rear diverging portion 25 and the rear coupling blocks 33. The guard member 4 is formed with a pair of lateral wings 41 that extend to cover the lateral surfaces of the rear diverging portion 25, and a pair of through openings 42. In this embodiment, the lateral wings 41 of the guard member 4 may be made from a light-reflecting material in order to enhance riding safety. When a bicycle that incorporates the saddle assembly falls down on the ground, the lateral wings 41 are able to protect the plastic layer 21 of the saddle body 2 from direct impact with the ground. Each of the through openings 42 is aligned with a respective one of the rear socket holes 26 to permit insertion of a respective one of the rear coupling blocks 33 into the respective one of the rear socket holes 26.

The saddle assembly further includes a pair of resilient washer components 5. Each of the resilient washer components 5 is disposed at the bottom side of the saddle body 2, is clamped between the guard member 4 at the rear diverging portion 25 and a respective one of the rear coupling blocks 33, and permits insertion of the respective one of the rear coupling blocks 33 into the corresponding one of the rear socket holes 26. Due to the washer components 5, rubbing between the saddle body 2 and the support bracket 3 can be minimized to result in a longer service life. Referring to FIGS. 2, 3, and 4, the support bracket 3 is connected to the bottom side of the saddle body 2 by inserting the insert portion 341 into the front socket hole 27, followed by inserting upwardly the rear coupling blocks 33 into the rear socket holes 26. The converging front end 32 of the support bracket 3 is connected to the front converging portion 24 at the bottom side of the saddle body 2, and the resilient hook parts 331 engage the retaining flange 261 in the respective one of the rear socket holes 26 in order to retain the respective one of the diverging arms 31 on the rear diverging portion 25 at the bottom side of the saddle body. Compared to the aforementioned conventional bicycle saddle, the support bracket 3 is not required to be deformed during the assembling process. Therefore, the structural integrity of the saddle assembly may be ensured, and the production yield of the same may be enhanced.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A saddle assembly comprising:
a saddle body including a front converging portion and a rear diverging portion and having a bottom side, said rear diverging portion being formed with a pair of rear socket holes in said bottom side of said saddle body, said rear socket holes being spaced apart from each other and opening downwardly; and
a support bracket having a converging front end that is connected to said front converging portion at said bottom side of said saddle body, a pair of diverging arms that extend rearwardly from said converging front end and that have distal ends opposite to said converging front end, and a pair of rear coupling blocks, each of which is provided on said distal end of a respective one of said diverging arms and is inserted upwardly into and engages a respective one of said rear socket holes to retain the respective one of said diverging arms on said rear diverging portion at said bottom side of said saddle body.

2. The saddle assembly as claimed in claim 1, wherein each of said rear coupling blocks is made from plastic and is molded over said distal end of the respective one of said diverging arms.

3. The saddle assembly as claimed in claim 1, wherein:
said rear diverging portion has a pair of hole-defining walls, each of which defines a respective one of said rear socket holes and each of which is formed with a retaining flange that extends into the respective one of said rear socket holes; and
each of said rear coupling blocks is formed with a pair of spaced apart resilient hook parts, said resilient hook parts being inserted upwardly into the respective one of said rear socket holes and engaging said retaining flange in the respective one of said rear socket holes to retain the respective one of said diverging arms on said rear diverging portion at said bottom side of said saddle body.

4. The saddle assembly as claimed in claim 1, wherein said support bracket further includes a front coupling block provided on said converging front end to connect said converging front end to said front converging portion at said bottom side of said saddle body.

5. The saddle assembly as claimed in claim 4, wherein said front coupling block is made from plastic and is formed integrally on said converging front end.

6. The saddle assembly as claimed in claim 4, wherein:
said front converging portion is formed with a front socket hole in said bottom side of said saddle body, said front socket hole opening toward said rear diverging portion; and
said front coupling block is formed with an insert portion that is inserted into said front socket hole to connect said converging front end to said front converging portion at said bottom side of said saddle body.

7. The saddle assembly as claimed in claim 4, wherein:
said front converging portion is formed with a screw hole in said bottom side of said saddle body;
said front coupling block is formed with a through hole to be aligned with said screw hole in said front converging portion; and
said saddle assembly further comprises a screw fastener extending through said through hole in said front coupling block and engaging threadedly said screw hole in said front converging portion.

8. The saddle assembly as claimed in claim 1, wherein:
said rear diverging portion of said saddle body has opposite lateral surfaces;
said saddle assembly further comprising a guard member disposed at said bottom side of said saddle body and clamped between said rear diverging portion and said rear coupling blocks, said guard member being formed with a pair of lateral wings that extend to cover said lateral surfaces of said rear diverging portion, and a pair of through openings, each of said through openings being aligned with a respective one of said rear socket holes to permit insertion of a respective one of said rear coupling blocks into the respective one of said rear socket holes.

9. The saddle assembly as claimed in claim 1, further comprising a pair of resilient washer components, each of which is disposed at said bottom side of said saddle body, is clamped between said rear diverging portion and a respective one of said rear coupling blocks, and permits insertion of the respective one of said rear coupling blocks into the corresponding one of said rear socket holes.
